(19) United States
(12) Patent Application Publication
(10) Pub. No.: US 2010/0063993 A1
(43) Pub. Date: Mar. 11, 2010

(54) SYSTEM AND METHOD FOR SOCIALLY AWARE IDENTITY MANAGER

(75) Inventors: Christopher William Higgins, Portland, OR (US); Marc Eliot Davis, San Francisco, CA (US); Joseph James O'Sullivan, Sunnyvale, CA (US); Christopher T. Paretti, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/206,172

(22) Filed: Sep. 8, 2008

(51) Int. Cl. G06F 15/16

(52) U.S. Cl. 709/203; 709/201

(57) ABSTRACT

A system and method for a Socially Aware Identity Manager. A request is received over a network from a first user for data relating to a second user, wherein the request comprises an identification of the second user. Spatial, temporal, topical, and social data available to the network relating to the second user is retrieved using a global index of data available to the network, wherein such data comprises at least one website comprising data relating to the second user, which can include social networking sites. The data relating to the second user is filtered using at least one filter criteria. A subset of the filtered data relating to the second user is selected using at least one selection criteria. The filtered subset of data relating to the second user is transmitted over the network to the first user.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for managing data relating to users on a network and, more particularly, to systems and methods for managing data relating to users on a network which is drawn, in part, from third party sources.

### BACKGROUND OF THE INVENTION

A great deal of information is generated when people use electronic devices, such as when people use mobile phones and cable set-top boxes. Such information, such as location, applications used, social network, physical and online locations visited, to name a few, could be used to deliver useful services and information to end users, and provide commercial opportunities to advertisers and retailers. However, most of this information is effectively abandoned due to deficiencies in the way such information can be captured. For example, and with respect to a mobile phone, information is generally not gathered while the mobile phone is idle (i.e., not being used by a user). Other information, such as presence of others in the immediate vicinity, time and frequency of messages to other users, and activities of a user's social network are also not captured effectively.

### SUMMARY OF THE INVENTION

In one embodiment, the invention is a method. A request is received over a network from a first user for data relating to a second user, wherein the request comprises an identification of the second user. Spatial, temporal, topical, and social data available to the network relating to the second user is retrieved using a global index of data available to the network. The data relating to the second user is filtered using at least one filter criteria. A subset of the filtered data relating to the second user is selected using at least one selection criteria. The filtered subset of data relating to the second user is transmitted over the network to the first user.

In another embodiment, the invention is a method. Spatial, temporal, topical, and social data available to a network relating to a plurality of users is gathered using a global index of data available to the network. Relationships are identified among the plurality of users using the gathered data. For each of the plurality of end users having at least one relationship to at least a second one of the plurality of end users it is determined, via the network, if the at relationship meets at least one publication criteria, and, if so a subset of the data relating to the second one of the plurality of end users that relates to at least one publication criteria is selected and transmitted to the end user having the relationship to the second one of the plurality of end users.

In another embodiment, the invention is a system comprising: a user manager that receives requests, over a network, from a first user for data relating to a second user, wherein the request comprises an identification of the second user; a matching manager that retrieves spatial, temporal, topical, and social data available to the network relating to the first user and the second user using a global index of data available to the network, filters the data relating to the second user, using at least one filter criteria, and selects a subset of the filtered data relating to the second user using at least one selection criteria; and a publishing manager that transmits, over the network, the filtered subset of data relating to the second user to the first user.

In another embodiment, the invention is a system that comprises a matching manager that: gathers, over a network, spatial, temporal, topical, and social data relating to a plurality of users using a global index of data available to the network, identifies relationships among the plurality of users using the gathered data. For each of the plurality of end users having at least one relationship to at least a second one of the plurality of end users the matching manager: determines if the relationship meets at least one publication criteria, and, if so selects, via the network, a subset of the data relating to the second one of the plurality of end users that relates to at least one publication criteria, and a publishing manager transmits, over the network the subset of the data relating to the second one of the plurality of end users to the end user having the relationship to the second one of the plurality of end users.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates relationships between real-world entities (RWE) and information objects (IO) on one embodiment of a W4 Communications Network (W4 COMN.)

FIG. 2 illustrates metadata defining the relationships between RWEs and IOs on one embodiment of a W4 COMN.

FIG. 3 illustrates a conceptual model of one embodiment of a W4 COMN.

FIG. 4 illustrates the functional layers of one embodiment of the W4 COMN architecture.

FIG. 5 illustrates the analysis components of one embodiment of a W4 engine as shown in FIG. 2.

FIG. 6 illustrates one embodiment of a W4 engine showing different components within the sub-engines shown in FIG. 5.

FIG. 7 illustrates one embodiment of the use of a W4 COMN for consolidating all information available about a user.

FIG. 8 illustrates one embodiment of how the users, devices and associate data objects shown in FIG. 7 can be defined to a W4 COMN.

FIG. 9 illustrates one embodiment of a data model showing how the RWEs and IOs shown in FIG. 8 can be related a user's profile within a W4 COMN.

FIG. 10 illustrates one embodiment of a process of how a network, for example, a W4 COMN, can use temporal, spatial, and social data relating to a user to provide a comprehensive profile of the user to other users.

FIG. 11 illustrates one embodiment of a process of how a network, for example, a W4 COMN, can use temporal, spatial, and social data relating to a user to selectively publish the user's profile data to other users.

FIG. 12 illustrates one embodiment of a socially aware identity manager engine capable of supporting the processes shown in FIGS. 10 and 11 above.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a genrel purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure the term “media” and “media content” should be understood to refer to binary data which contains content which can be of interest to an end user. By way of example, and not limitation, the term “media” and “media content” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be encrypted, compressed, and/or can contained embedded metadata.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

For the purposes of this disclosure an engine is a software, hardware, or firmware (or combinations thereof) system, process or functionality that performs or facilitates the processes, features, and/or functions described herein (with or without human interaction or augmentation).

Embodiments of the present invention utilize information provided by a network which is capable of providing data collected and stored by multiple devices on a network. Such information may include, without limitation, temporal information, spatial information, and user information relating to a specific user or hardware device. User information may include, without limitation, user demographics, user preferences, user social networks, and user behavior. One embodiment of such a network is a W4 Communications Network.

A “W4 Communications Network” or W4 COMN, provides information related to the “Who, What, When and Where” of interactions within the network. In one embodiment, the W4 COMN is a collection of users, devices and processes that foster both synchronous and asynchronous communications between users and their proxies providing an instrumented network of sensors providing data recognition and collection in real-world environments about any subject, location, user or combination thereof.

In one embodiment, the W4 COMN can handle the routing/addressing, scheduling, filtering, prioritization, replying, forwarding, storing, deleting, privacy, transacting, triggering of a new message, propagating changes, transcoding and linking. Furthermore, these actions can be performed on any communication channel accessible by the W4 COMN.

In one embodiment, the W4 COMN uses a data modeling strategy for creating profiles for not only users and locations, but also any device on the network and any kind of user-defined data with user-specified conditions. Using Social, Spatial, Temporal and Logical data available about a specific user, topic or logical data object, every entity known to the W4 COMN can be mapped and represented against all other known entities and data objects in order to create both a micro graph for every entity as well as a global graph that relates all known entities with one another. In one embodiment, such relationships between entities and data objects are stored in a global index within the W4 COMN.

In one embodiment, a W4 COMN network relates to what may be termed “real-world entities”, hereinafter referred to as RWEs. A RWE refers to, without limitation, a person, device, location, or other physical thing known to a W4 COMN. In one embodiment, each RWE known to a W4 COMN is assigned a unique W4 identification number that identifies the RWE within the W4 COMN.

RWEs can interact with the network directly or through proxies, which can themselves be RWEs. Examples of RWEs that interact directly with the W4 COMN include any device such as a sensor, motor, or other piece of hardware connected to the W4 COMN in order to receive or transmit data or control signals. RWE may include all devices that can serve as network nodes or generate, request and/or consume data in a networked environment or that can be controlled through a network. Such devices include any kind of “dumb” device purpose-designed to interact with a network (e.g., cell phones, cable television set top boxes, fax machines, telephones, and radio frequency identification (RFID) tags, sensors, etc.).

Examples of RWEs that may use proxies to interact with W4 COMN network include non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) may be considered RWE that use proxies to interact with the network, where software applications executing on the device that serve as the devices' proxies.

In one embodiment, a W4 COMN may allow associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 CONN.

An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association can include the user identifying a specific relationship between the user and the RWE (e.g., this is my device, this is my home appliance, this person is my friend/father/son/etc., this device is shared between me and other users, etc.). RWEs can also be implicitly associated with a user based on a current situation. For example, a weather sensor on the W4 COMN can be implicitly associated with a user based on information indicating that the user lives or is passing near the sensor's location.

In one embodiment, a W4 COMN network may additionally include what may be termed “information-objects”, hereinafter referred to as IOs. An information object (IO) is a logical object that may store, maintain, generate or otherwise provides data for use by RWEs and/or the W4 COMN. In one embodiment, data within in an IO can be revised by the act of an RWE An IO within in a W4 COMN can be provided a unique W4 identification number that identifies the IO within the W4 COMN.

In one embodiment, IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In one embodiment, IOs include any executing process or application that consumes or generates data such as an email communication application (such as OUTLOOK by MICROSOFT, or YAHOO! MAIL by YAHOO!), a calendaring application, a word processing application, an image editing application, a media player application, a weather monitoring application, a browser application and a web page server application. Such active IOs can or can not serve as a proxy for one or more RWEs. For example, voice communication software on a smart phone can serve as the proxy for both the smart phone and for the owner of the smart phone.

In one embodiment, for every IO there are at least three classes of associated RWEs. The first is the RWE that owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs that access the IO in order to obtain data from the IO for some purpose.

Within the context of a W4 COMN, “available data” and “W4 data” means data that exists in an IO or data that can be collected from a known IO or RWE such as a deployed sensor. Within the context of a W4 COMN, “sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

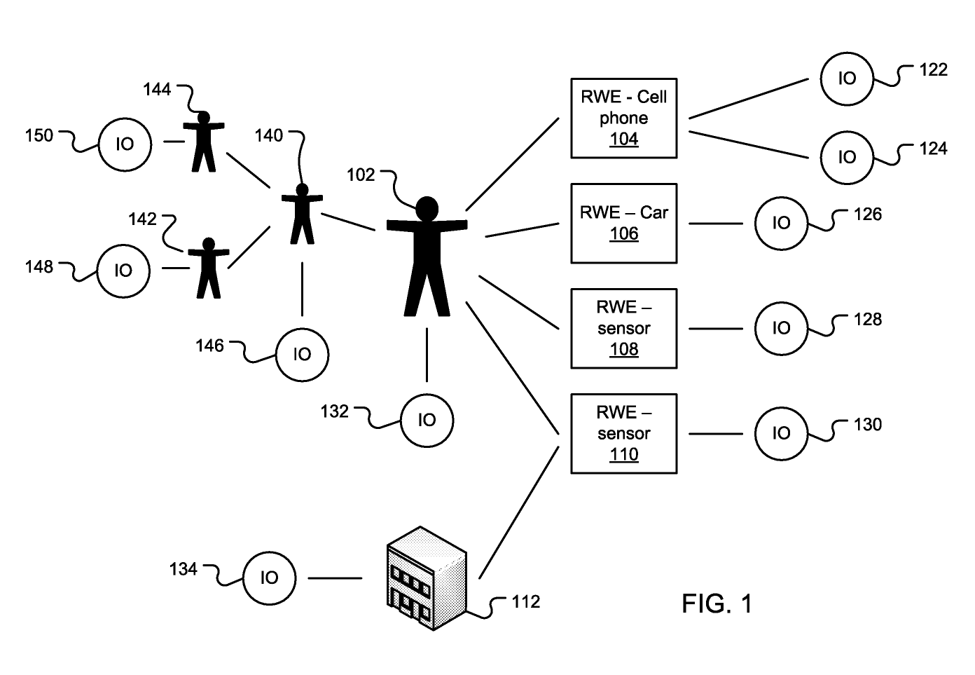

FIG. 1 illustrates one embodiment of relationships between RWEs and IOs on a W4 COMN. A user 102 is a RWE provided with a unique network ID. The user 102 may be a human that communicates with the network using proxy devices 104, 106, 108, 110 associated with the user 102, all of which are RWEs having a unique network ID. These proxies can communicate directly with the W4 COMN or can communicate with the W4 COMN using IOs such as applications executed on or by a proxy device.

In one embodiment, the proxy devices 104, 106, 108, 110 can be explicitly associated with the user 102. For example, one device 104 can be a smart phone connected by a cellular service provider to the network and another device 106 can be a smart vehicle that is connected to the network. Other devices can be implicitly associated with the user 102.

For example, one device 108 can be a “dumb” weather sensor at a location matching the current location of the user's cell phone 104, and thus implicitly associated with the user 102 while the two RWEs 104, 108 are co-located. Another implicitly associated device 110 can be a sensor 110 for physical location 112 known to the W4 COMN. The location 112 is known, either explicitly (through a user-designated relationship, e.g., this is my home, place of employment, parent, etc.) or implicitly (the user 102 is often co-located with the RWE 112 as evidenced by data from the sensor 110 at that location 112), to be associated with the first user 102.

The user 102 can be directly associated with one or more persons 140, and indirectly associated with still more persons 142, 144 through a chain of direct associations. Such associations can be explicit (e.g., the user 102 can have identified the associated person 140 as his/her father, or can have identified the person 140 as a member of the user's social network) or implicit (e.g., they share the same address). Tracking the associations between people (and other RWEs as well) allows the creation of the concept of “intimacy”, where intimacy may be defined as a measure of the degree of association between two people or RWEs. For example, each degree of removal between RWEs can be considered a lower level of intimacy, and assigned lower intimacy score. Intimacy can be based solely on explicit social data or can be expanded to include all W4 data including spatial data and temporal data.

In one embodiment, each RWE 102, 104, 106, 108, 110, 112, 140, 142, 144 of a W4 COMN can be associated with one or more IOs as shown. FIG. 1 illustrates two IOs 122, 124 as associated with the cell phone device 104. One IO 122 can be a passive data object such as an event record that is used by scheduling/calendaring software on the cell phone, a contact IO used by an address book application, a historical record of a transaction made using the device 104 or a copy of a message sent from the device 104. The other IO 124 can be an active software process or application that serves as the device's proxy to the W4 COMN by transmitting or receiving data via the W4 COMN. Voice communication software, scheduling/calendaring software, an address book application or a text messaging application are all examples of IOs that can communicate with other IOs and RWEs on the network. IOs may additionally relate to topics of interest to one or more RWEs, such topics including, without limitation, musical artists, genre of music, a location and so forth.

The IOs 122, 124 can be locally stored on the device 104 or stored remotely on some node or datastore accessible to the W4 COMN, such as a message server or cell phone service datacenter. The IO 126 associated with the vehicle 108 can be an electronic file containing the specifications and/or current status of the vehicle 108, such as make, model, identification number, current location, current speed, current condition, current owner, etc. The IO 128 associated with sensor 108 can identify the current state of the subject(s) monitored by the sensor 108, such as current weather or current traffic. The IO 130 associated with the cell phone 110 can be information in a database identifying recent calls or the amount of charges on the current bill.

RWEs which can only interact with the W4 COMN through proxies, such as people 102, 140, 142, 144, computing devices 104, 106 and locations 112, can have one or more IOs 132, 134, 146, 148, 150 directly associated with them which contain RWE-specific information for the associated RWE. For example, IOs associated with a person 132, 146, 148, 150 can include a user profile containing email addresses, telephone numbers, physical addresses, user preferences, identification of devices and other RWEs associated with the user. The IOs may additionally include records of the user's past interactions with other RWEs on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.).

Another example of IOs associated with a person 132, 146, 148, 150 includes remote applications through which a person can communicate with the W4 COMN such as an account with a web-based email service such as Yahoo! Mail. A location's IO 134 can contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In one embodiment, RWEs and IOs are correlated to identify relationships between them. RWEs and IOs may be correlated using metadata. For example, if an TO is a music file, metadata for the file can include data identifying the artist, song, etc., album art, and the format of the music data. This metadata can be stored as part of the music file or in one or more different IOs that are associated with the music file or both. W4 metadata can additionally include the owner of the music file and the rights the owner has in the music file. As another example, if the IO is a picture taken by an electronic camera, the picture can include in addition to the primary image data from which an image can be created on a display, metadata identifying when the picture was taken, where the camera was when the picture was taken, what camera took the picture, who, if anyone, is associated (e.g., designated as the camera's owner) with the camera, and who and what are the subjects of/in the picture. The W4 COMN uses all the available metadata in order to identify implicit and explicit associations between entities and data objects.

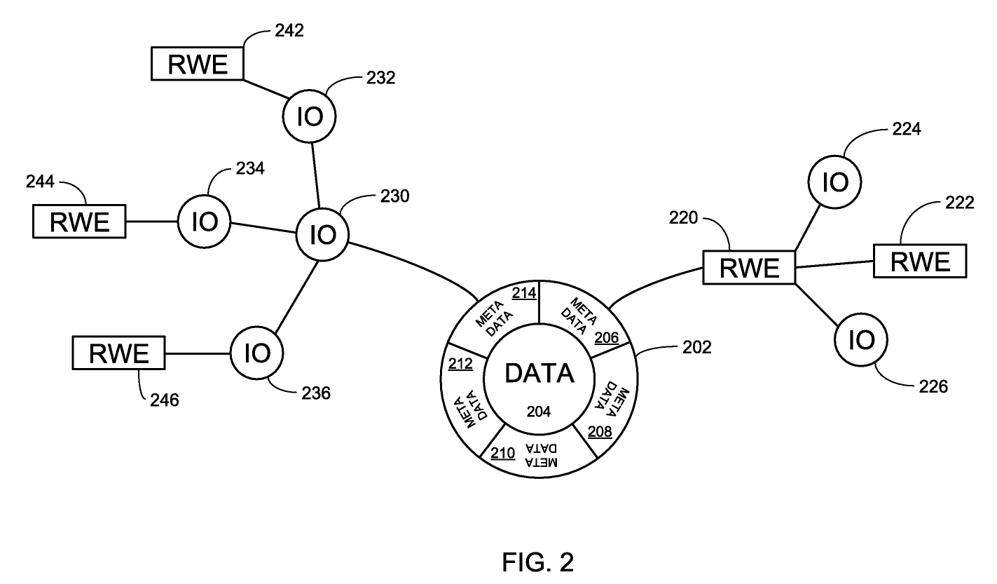

FIG. 2 illustrates one embodiment of metadata defining the relationships between RWEs and IOs on the W4 COMN. In the embodiment shown, an IO 202 includes object data 204 and five discrete items of metadata 206, 208, 210, 212, 214. Some items of metadata 208, 210, 212 can contain information related only to the object data 204 and unrelated to any other IO or RWE. For example, a creation date, text or an image that is to be associated with the object data 204 of the IO 202.

Some of items of metadata 206, 214, on the other hand, can identify relationships between the IO 202 and other RWEs and IOs. As illustrated, the IO 202 is associated by one item of metadata 206 with an RWE 220 that RWE 220 is further associated with two IOs 224, 226 and a second RWE 222 based on some information known to the W4 COMN. For example, could describe the relations between an image (IO 202) containing metadata 206 that identifies the electronic camera (the first RWE 220) and the user (the second RWE 224) that is known by the system to be the owner of the camera 220. Such ownership information can be determined, for example, from one or another of the IOs 224, 226 associated with the camera 220.

FIG. 2 also illustrates metadata 214 that associates the IO 202 with another IO 230. This IO 230 is itself associated with three other IOs 232, 234, 236 that are further associated with different RWEs 242, 244, 246. This part of FIG. 2, for example, could describe the relations between a music file (IO 202) containing metadata 206 that identifies the digital rights file (the first IO 230) that defines the scope of the rights of use associated with this music file 202. The other IOs 232, 234, 236 are other music files that are associated with the rights of use and which are currently associated with specific owners (RWEs 242, 244, 246).

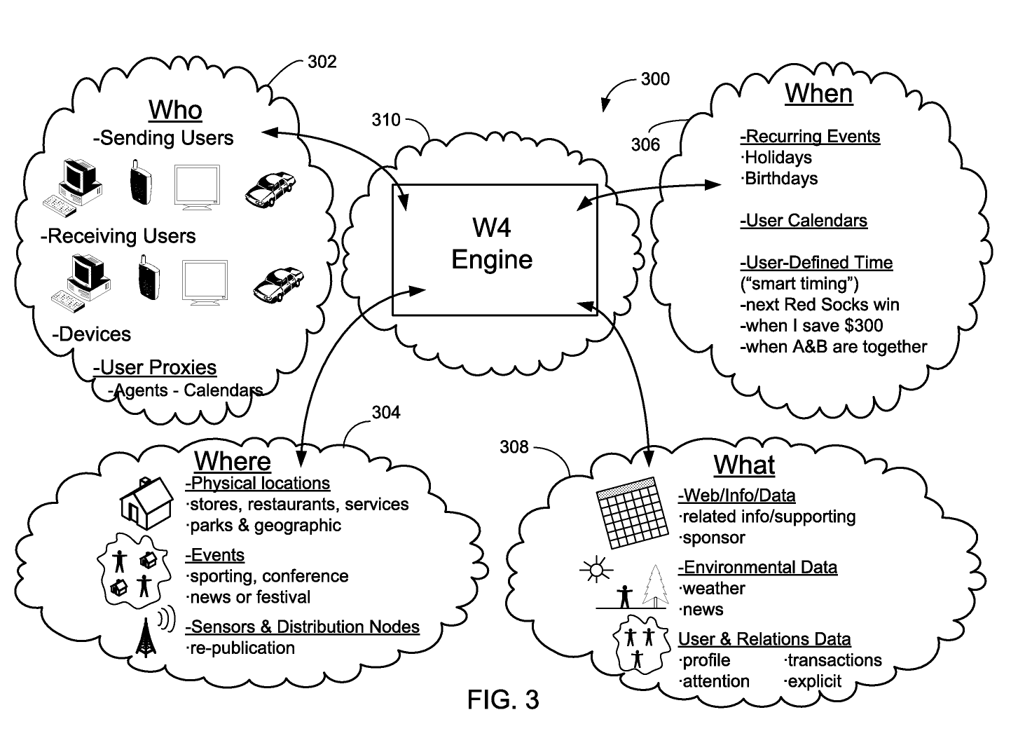

FIG. 3 illustrates one embodiment of a conceptual model of a W4 COMN. The W4 COMN 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc.

In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs).

The What cloud 308 is comprised of all known data—web or private, commercial or user—accessible to the W4 COMN, including for example environmental data like weather and news, RWE-generated data, IOs and IO data, user data, models, processes and applications. Thus, conceptually, most data is contained in the What cloud 308.

Some entities, sensors or data may potentially exist in multiple clouds either disparate in time or simultaneously. Additionally, some IOs and RWEs can be composites in that they combine elements from one or more clouds. Such composites can be classified as appropriate to facilitate the determination of associations between RWEs and IOs. For example, an event consisting of a location and time could be equally classified within the When cloud 306, the What cloud 308 and/or the Where cloud 304.

In one embodiment, a W4 engine 310 is center of the W4 COMN's intelligence for making all decisions in the W4 COMN. The W4 engine 310 controls all interactions between each layer of the W4 COMN and is responsible for executing any approved user or application objective enabled by W4 COMN operations or interoperating applications. In an embodiment, the W4 COMN is an open platform with standardized, published APIs for requesting (among other things) synchronization, disambiguation, user or topic addressing, access rights, prioritization or other value-based ranking, smart scheduling, automation and topical, social, spatial or temporal alerts.

One function of the W4 COMN is to collect data concerning all communications and interactions conducted via the W4 COMN, which can include storing copies of IOs and information identifying all RWEs and other information related to the IOs (e.g., who, what, when, where information). Other data collected by the W4 COMN can include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

The W4 engine 310 is also responsible for identifying RWEs and relationships between RWEs and IOs from the data and communication streams passing through the W4 COMN. The function of identifying RWEs associated with or implicated by IOs and actions performed by other RWEs may be referred to as entity extraction. Entity extraction can include both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object with only where only W4 metadata related to the object is visible, but internal data of the IO (i.e., the actual primary or object data contained within the object) are not, and thus metadata extraction is limited to the metadata. Alternatively, if internal data of the IO is visible, it can also be used in entity extraction, e.g. strings within an email are extracted and associated as RWEs to for use in determining the relationships between the sender, user, topic or other RWE or IO impacted by the object or process.

In the embodiment shown, the W4 engine 310 can be one or a group of distributed computing devices, such as a general-purpose personal computers (PCs) or purpose built server computers, connected to the W4 COMN by communication hardware and/or software. Such computing devices can be a single device or a group of devices acting together. Computing devices can be provided with any number of program modules and data files stored in a local or remote mass storage device and local memory (e.g., RAM) of the computing device. For example, as mentioned above, a computing device can include an operating system suitable for controlling the operation of a networked computer, such as the WINDOWS XP or WINDOWS SERVER operating systems from MICROSOFT CORPORATION.

Some RWEs can also be computing devices such as, without limitation, smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a wi-fi, a WiMAX (802.36), a Bluetooth or a cellular telephone connection.

Local data structures, including discrete IOs, can be stored on a computer-readable medium (not shown) that is connected to, or part of, any of the computing devices described herein including the W4 engine 310. For example, in one embodiment, the data backbone of the W4 COMN, discussed below, includes multiple mass storage devices that maintain the IOs, metadata and data necessary to determine relationships between RWEs and IOs as described herein.

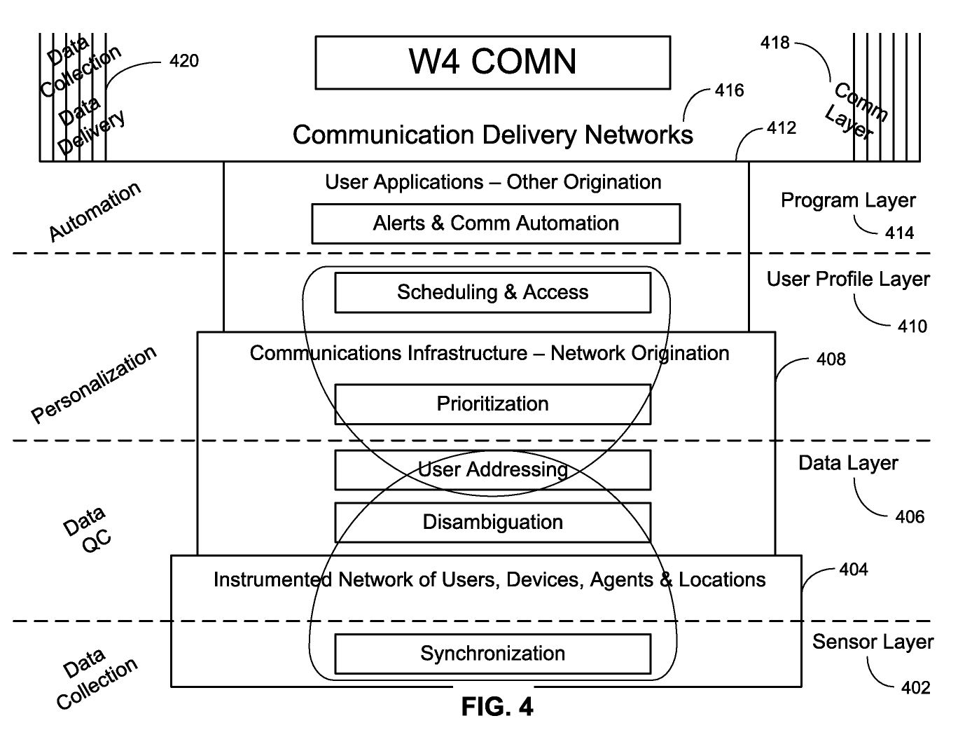

FIG. 4 illustrates one embodiment of the functional layers of a W4 COMN architecture. At the lowest layer, referred to as the sensor layer 402, is the network 404 of the actual devices, users, nodes and other RWEs. Sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The data layer 406 stores and catalogs the data produced by the sensor layer 402. The data can be managed by either the network 404 of sensors or the network infrastructure 406 that is built on top of the instrumented network of users, devices, agents, locations, processes and sensors. The network infrastructure 408 is the core under-the-covers network infrastructure that includes the hardware and software necessary to receive that transmit data from the sensors, devices, etc. of the network 404. It further includes the processing and storage capability necessary to meaningfully categorize and track the data created by the network 404.

The user profiling layer 410 performs the W4 COMN's user profiling functions. This layer 410 can further be distributed between the network infrastructure 408 and user applications/processes 412 executing on the W4 engine or disparate user computing devices. Personalization is enabled across any single or combination of communication channels and modes including email, IM, texting (SMS, etc.), photo-blogging, audio (e.g. telephone call), video (teleconferencing, live broadcast), games, data confidence processes, security, certification or any other W4 COMM process call for available data.

In one embodiment, the user profiling layer 410 is a logic-based layer above all sensors to which sensor data are sent in the rawest form to be mapped and placed into the W4 COMN data backbone 420. The data (collected and refined, related and deduplicated, synchronized and disambiguated) are then stored in one or a collection of related databases available applications approved on the W4 COMN. Network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from outside the network, e.g., RWEs such as users, locations, proxies and processes, come from the applications layer 414 of the W4 COMN. Some applications can be developed by the W4 COMN operator and appear to be implemented as part of the communications infrastructure 408, e.g. email or calendar programs because of how closely they operate with the sensor processing and user profiling layer 410. The applications 412 also serve as a sensor in that they, through their actions, generate data back to the data layer 406 via the data backbone concerning any data created or available due to the applications execution.

In one embodiment, the applications layer 414 can also provide a user interface (UI) based on device, network, carrier as well as user-selected or security-based customizations. Any UI can operate within the W4 COMN if it is instrumented to provide data on user interactions or actions back to the network. In the case of W4 COMN enabled mobile devices, the UI can also be used to confirm or disambiguate incomplete W4 data in real-time, as well as correlation, triangulation and synchronization sensors for other nearby enabled or non-enabled devices.

At some point, the network effects enough enabled devices allow the network to gather complete or nearly complete data (sufficient for profiling and tracking) of a non-enabled device because of its regular intersection and sensing by enabled devices in its real-world location.

Above the applications layer 414, or hosted within it, is the communications delivery network 416. The communications delivery network can be operated by the W4 COMN operator or be independent third-party carrier service. Data may be delivered via synchronous or asynchronous communication. In every case, the communication delivery network 414 will be sending or receiving data on behalf of a specific application or network infrastructure 408 request.

The communication delivery layer 418 also has elements that act as sensors including W4 entity extraction from phone calls, emails, blogs, etc. as well as specific user commands within the delivery network context. For example, “save and prioritize this call” said before end of call can trigger a recording of the previous conversation to be saved and for the W4 entities within the conversation to analyzed and increased in weighting prioritization decisions in the personalization/user profiling layer 410.

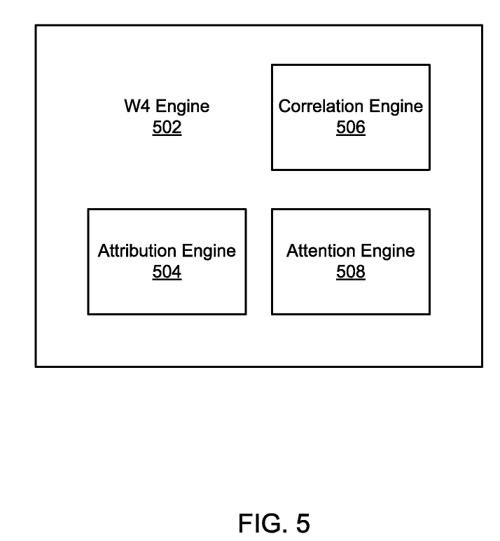

FIG. 5 illustrates one embodiment of the analysis components of a W4 engine as shown in FIG. 3. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the W4 COMN.

The correlation engine 506 can operates two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of the correlation engine 506 is done by graphing the available data, using, for example, one or more histograms A histogram is a mapping technique that counts the number of observations that fall into various disjoint categories (i.e. bins.). By selecting each IO, RWE, and other known parameters (e.g., times, dates, locations, etc.) as different bins and mapping the available data, relationships between RWEs, IOs and the other parameters can be identified. A histogram of all RWEs and IOs is created, from which correlations based on the graph can be made.

As a pre-processor, the correlation engine 506 monitors the information provided by RWEs in order to determine if any conditions are identified that can trigger an action on the part of the W4 engine 502. For example, if a delivery condition has been associated with a message, when the correlation engine 506 determines that the condition is met, it can transmit the appropriate trigger information to the W4 engine 502 that triggers delivery of the message.

The attention engine 508 instruments all appropriate network nodes, clouds, users, applications or any combination thereof and includes close interaction with both the correlation engine 506 and the attribution engine 504.

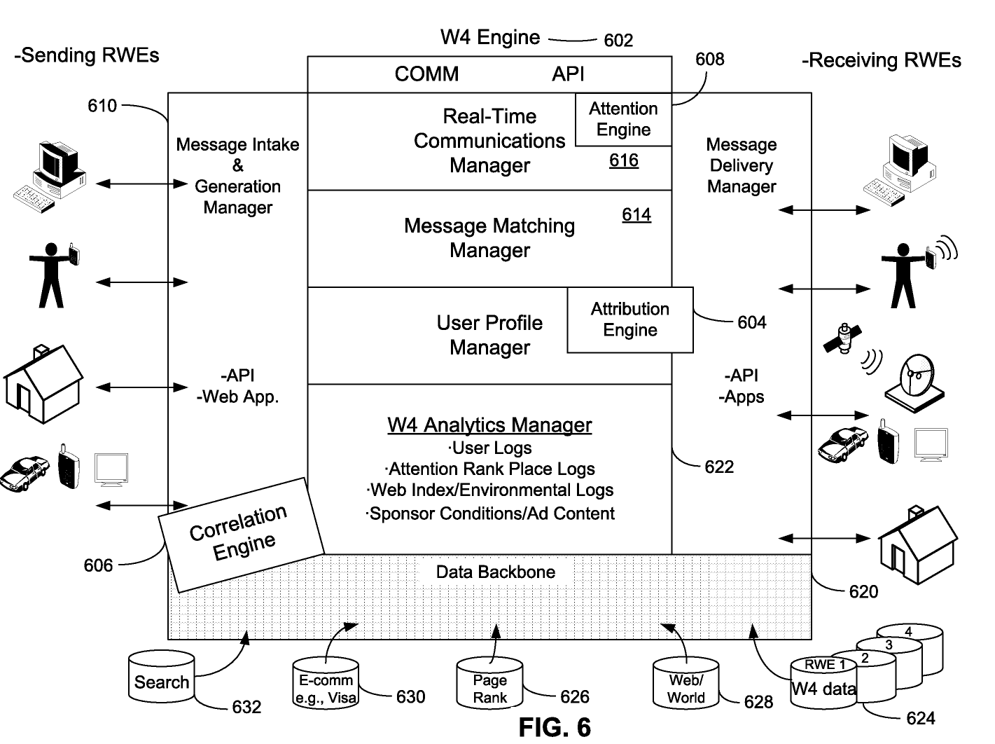

FIG. 6 illustrates one embodiment of a W4 engine showing different components within the sub-engines described above with reference to FIG. 4. In one embodiment the W4 engine 602 includes an attention engine 608, attribution engine 604 and correlation engine 606 with several sub-managers based upon basic function.

The attention engine 608 includes a message intake and generation manager 610 as well as a message delivery manager 612 that work closely with both a message matching manager 614 and a real-time communications manager 616 to deliver and instrument all communications across the W4 COMN.

The attribution engine 604 works within the user profile manager 618 and in conjunction with all other modules to identify, process/verify and represent ownership and rights information related to RWEs, IOs and combinations thereof.

The correlation engine 606 dumps data from both of its channels (sensors and processes) into the same data backbone 620 which is organized and controlled by the W4 analytics manager 622. The data backbone 620 includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any W4 COMN process, IO or event. Because of the amount of data that the W4 COMN will potentially store, the data backbone 620 includes numerous database servers and datastores in communication with the W4 COMN to provide sufficient storage capacity.

The data collected by the W4 COMN includes spatial data, temporal data, RWE interaction data, IO content data (e.g., media data), and user data including explicitly-provided and deduced social and relationship data. Spatial data can be any data identifying a location associated with an RWE. For example, the spatial data can include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data can be passively collected time data (e.g., time data from a clock resident on the electronic device, or time data from a network clock), or the temporal data can be actively collected time data, such as time data entered by the user of the electronic device (e.g., a user maintained calendar).

Logical and IO data refers to the data contained by an IO as well as data associated with the IO such as creation time, owner, associated RWEs, when the IO was last accessed, the topic or subject of the IO (from message content or “re” or subject line, as some examples) etc. For example, an IO may relate to media data. Media data can include any data relating to presentable media, such as audio data, visual data, and audiovisual data. Audio data can be data relating to downloaded music, such as genre, artist, album and the like, and includes data regarding ringtones, ringbacks, media purchased, playlists, and media shared, to name a few. The visual data can be data relating to images and/or text received by the electronic device (e.g., via the Internet or other network). The visual data can be data relating to images and/or text sent from and/or captured at the electronic device.

Audiovisual data can be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data can include data relating to the user's RSS feeds, subscriptions, group memberships, game services, alerts, and the like.

The media data can include non-network activity, such as image capture and/or video capture using an electronic device, such as a mobile phone. The image data can include metadata added by the user, or other data associated with the image, such as, with respect to photos, location when the photos were taken, direction of the shot, content of the shot, and time of day, to name a few. Media data can be used, for example, to deduce activities information or preferences information, such as cultural and/or buying preferences information.

Relationship data can include data relating to the relationships of an RWE or IO to another RWE or IO. For example, the relationship data can include user identity data, such as gender, age, race, name, social security number, photographs and other information associated with the user's identity. User identity information can also include e-mail addresses, login names and passwords. Relationship data can further include data identifying explicitly associated RWEs. For example, relationship data for a cell phone can indicate the user that owns the cell phone and the company that provides the service to the phone. As another example, relationship data for a smart car can identify the owner, a credit card associated with the owner for payment of electronic tolls, those users permitted to drive the car and the service station for the car.

Relationship data can also include social network data. Social network data includes data relating to any relationship that is explicitly defined by a user or other RWE, such as data relating to a user's friends, family, co-workers, business relations, and the like. Social network data can include, for example, data corresponding with a user-maintained electronic address book. Relationship data can be correlated with, for example, location data to deduce social network information, such as primary relationships (e.g., user-spouse, user-children and user-parent relationships) or other relationships (e.g., user-friends, user-co-worker, user-business associate relationships). Relationship data also can be utilized to deduce, for example, activities information.

Interaction data can be any data associated with user interaction of the electronic device, whether active or passive. Examples of interaction data include interpersonal communication data, media data, relationship data, transactional data and device interaction data, all of which are described in further detail below. Table 1, below, is a non-exhaustive list including examples of electronic data.

TABLE 1
Examples of Electronic Data

| Spatial Data | Temporal Data | Interaction Data |
|---|---|---|
| Cell tower | Time stamps | Interpersonal |
| GPRS | Local clock | communications |
| GPS | Network clock | Media |
| WiFi | User input of time | Relationships |
| Personal area network | | Transactions |
| Network access points | | Device interactions |
| User input of location | | |
| Geo-coordinates | | |

Interaction data includes communication data between any RWEs that is transferred via the W4 COMN. For example, the communication data can be data associated with an incoming or outgoing short message service (SMS) message, email message, voice call (e.g., a cell phone call, a voice over IP call), or other type of interpersonal communication related to an RWE. Communication data can be correlated with, for example, temporal data to deduce information regarding frequency of communications, including concentrated communication patterns, which can indicate user activity information.

The interaction data can also include transactional data. The transactional data can be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data can be utilized, for example, to deduce activities and preferences information. The transactional information can also be used to deduce types of devices and/or services the user owns and/or in which the user can have an interest.

The interaction data can also include device or other RWE interaction data. Such data includes both data generated by interactions between a user and a RWE on the W4 COMN and interactions between the RWE and the W4 COMN. RWE interaction data can be any data relating to an RWE's interaction with the electronic device not included in any of the above categories, such as habitual patterns associated with use of an electronic device data of other modules/applications, such as data regarding which applications are used on an electronic device and how often and when those applications are used. As described in further detail below, device interaction data can be correlated with other data to deduce information regarding user activities and patterns associated therewith. Table 2, below, is a non-exhaustive list including examples of interaction data.

TABLE 2
Examples of Interaction Data

| Type of Data | Example(s) |
|---|---|
| Interpersonal | Text-based communications, such as SMS and e- |
| communication | mail |
| data | Audio-based communications, such as voice |
| | calls, voice notes, voice mail |
| | Media-based communications, such as |
| | multimedia messaging service (MMS) |
| | communications |
| | Unique identifiers associated with a |
| | communication, such as phone numbers, e-mail |
| | addresses, and network addresses |
| Media data | Audio data, such as music data (artist, genre, |
| | track, album, etc.) |
| | Visual data, such as any text, images and video |
| | data, including Internet data, picture data, |
| | podcast data and playlist data |
| | Network interaction data, such as click patterns |
| | and channel viewing patterns |
| Relationship data | User identifying information, such as name, age, |
| | gender, race, and social security number |
| | Social network data |
| Transactional data | Vendors |
| | Financial accounts, such as credit cards and banks |
| | data |
| | Type of merchandise/services purchased |
| | Cost of purchases |
| | Inventory of purchases |
| Device interaction data | Any data not captured above dealing with user |
| | interaction of the device, such as patterns of use |
| | of the device, applications utilized, and so forth |

### Socially Aware Identity Manager

One of the most rapidly growing areas of the Internet is social networking. Every year, more and more Internet users meet and communicate using various services for facilitating interaction among users. The most prominent among such services in the past few years are social networking web sites such as Facebook, MySpace, and LinkedIn. Such web sites allow users to share limited amounts of information about themselves with a wide community of other users through, for example, profiles, news feeds and interest groups.

Users can also reach out to a larger community by other means. Many sites provide discussion groups which can have world wide distribution, such as, for example, Usenet groups, or media sharing sites such as YouTube. Other sites provide chat rooms where users can interact in real-time with various forms of instant messaging. More sophisticated users may construct their own web page or set up personal websites that allow any Internet user to find and browse selected information about the web page owner.

The more social networking websites and services that a user makes use of, the more information about the user is available on the Internet, but such information is scattered. A user can have multiple memberships in various social networking sites, but the memberships have, functionally, no relationship to each other. Users who meet through a particular service, can only view each other's profile and interests thorough the narrow lens of a single source. It can be the case that a user can only determine that a second user has a cluster of interests similar to the user by viewing information related to the second user from multiple sources, which may be cumbersome at best.

Furthermore, there is much data that a user generates over time that may not be reflected in any social networking web site. For example, text in a user's emails or instant messages may reveal a great deal about a user's activities or preferences. Transaction data may reveal where a user shops and eats, and what kind of merchandise they purchase. Data relating to the physical location of the user over time reveals where a user goes, hints at what they may be doing. Shows what routes they prefer, what shops they prefer, what modes of transportation and entertainment they enjoy.

Ideally, a user may wish to establish a single, unified identity or virtual profile that consolidates all the information available about the user from various sources and allows the user to share all, or portions of, the user's consolidated data with other users. Such an ID could also allow a user to locate other users having similar interests, activities or demographic attributes.

For example, suppose user A meets user B for the first time, either in-person, offline by-proxy, online in real-time or online asynchronously by proxy. User A may wish to view data relating to user B. If user B has a single ID that consolidates all known information about user B, then user A can easily view such information. User B may choose to keep some information confidential, or allow user A to access all of user B's information. If user A has a single ID that consolidates all known information about user A, such information could be compared to user B's information to determine what they may have in common.

The embodiments of the present invention discussed below illustrate application of the present invention within a W4 COMN. Nevertheless, it is understood that the invention can be implemented using any networked system in which is capable of consolidating data regarding users from multiple sources including third party websites, such as social networking web sites, user profile data, as well as temporal, spatial, topical and social data relating to users and their devices

A W4 COMN can provide a platform that enables users to establish a single, unified identity or virtual profile that consolidates all the information available about the user. The W4 COMN is able to achieve such a result, in part, because the W4 COMN access to aggregated user data profiles and behavior patterns over-time, as well as third party websites hosting data relating to users.

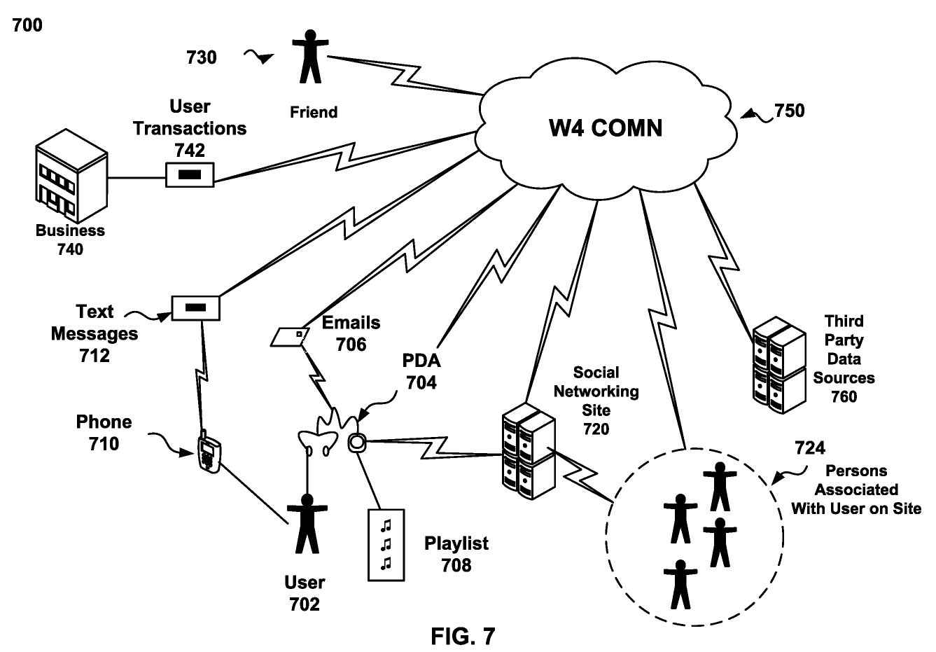

FIG. 7 illustrates one embodiment of the use of a W4 COMN for consolidating all information available about a user.

In the illustrated embodiment, a user 702 is known to the W4 COMN. The user 702 has a PDA 704, also known to the W4 COMN, which has access to the Internet and can be used, inter alia, for sending emails 706. The PDA 704 is further capable of playing media files and has a playlist 708. The user 702 additionally has a phone 710 known to the W4 COMN. The phone is used for voice calls and for sending and receiving text messages 712. The physical location of the PDA 704 and the phone 710 can be determined by the W4 COMN using a conventional methodology such as, for example, triangulation of cell signals, determination of the nearest cell tower or through an embedded GPS device or known co-location with a GPS-enabled device.

The user 702 is a member of a social networking site 720 which the user can access over the Internet using a device with Internet access, for example, the PDA 704. The user 702 is associated with a group 724 of other users who are also members of the social networking site 720. Such users 724 may be designated by the user 702 on the social networking site 720 as friends, business associates or any other type of contact. The user also has a friend 730 who is not associated with a social networking site.

The emails 706, the text messages 712, and the playlist 708 are known to the W4 COMN and can be accumulated, analyzed and archived on data storage available to the network. The social networking site 720 is known to the W4 COMN and the W4 COMN has sufficient information to access the user's 702 account on the site. Such information can include, for example, the user's user ID and password for the site. The illustrated embodiment shows one social networking site, but the user could be a member of any number of social networking sites or other subscriber based websites, and all such sites could be known to, and accessed by, the W4 COMN.

The user 702 patronizes a business 740. The transactions 742 the user executes with the business are known to the W4 COMN. The W4 COMN can archive all of a user's transactions on storage available to the network, or may access such data through third party data sources 760 known to the W4 COMN. Such sources may include websites which provide access to the user's 702 bank account information or credit or debit card transaction information. Third party data sources 760 can also include websites, RSS feeds and any other type of network accessible data sources that provide any type of data relevant to entities or objects defined within the W4 COMN, such as, for example, a metadata provider that provides metadata for media objects.

Outside the finite set of data, persons and locations known to the end user are a large, and potentially unbounded set of entities and data known to the network that can be indirectly related to an end user. For example, the user's friend 730 may patronize different businesses or may have his or her own unique playlists. The network collects spatial, temporal, social, and topical data, including behavioral and interaction data about these entities as well.

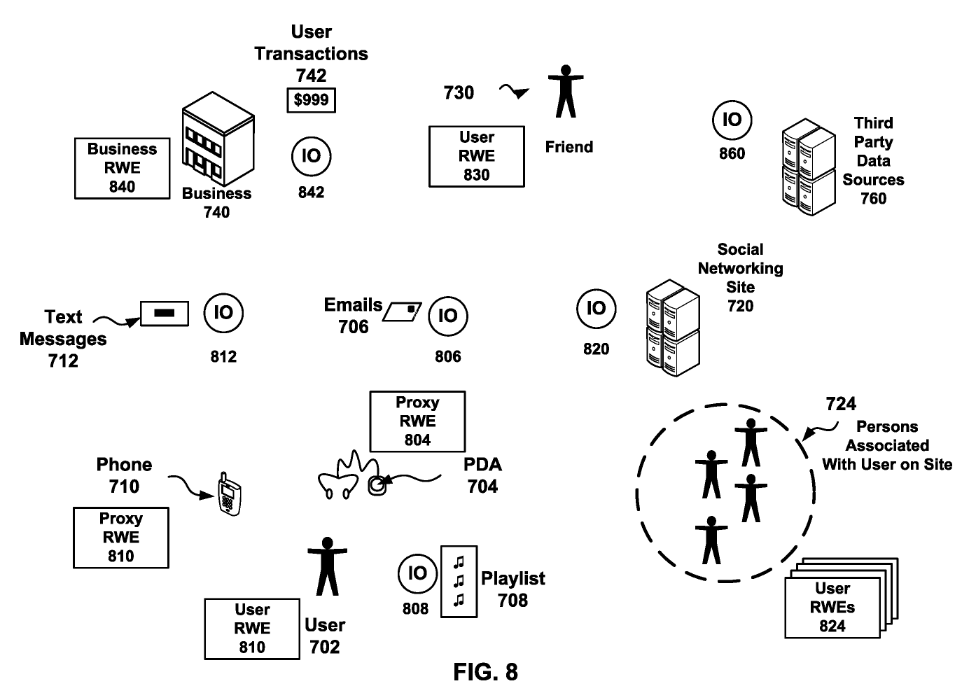

FIG. 8 illustrates one embodiment of how the users, devices and associate data objects shown in FIG. 7 can be defined to a W4 COMN.

Individuals 702, 724, and 730 are represented as user RWEs, 802, 824, and 830 respectively. The individual's devices 704 and 710 are represented as proxy RWEs 704 and 710. The business 740 is represented as a business RWE 840. The W4 COMN collects spatial data, temporal data, RWE interaction data, IO content data (e.g., media data), and user data including explicitly-provided and deduced social and relationship data for all of the RWEs shown in FIG. 8. The social networking site 720 and third party data sources 760 are, in one embodiment, defined to the W4 COMN as active IOs 820 and 860. Emails 706, the playlist 708, text messages 712 and user transactions 742 are, in one embodiment, defined to the W4 COMN as passive IOs 806, 808, 812 and 842 respectively.

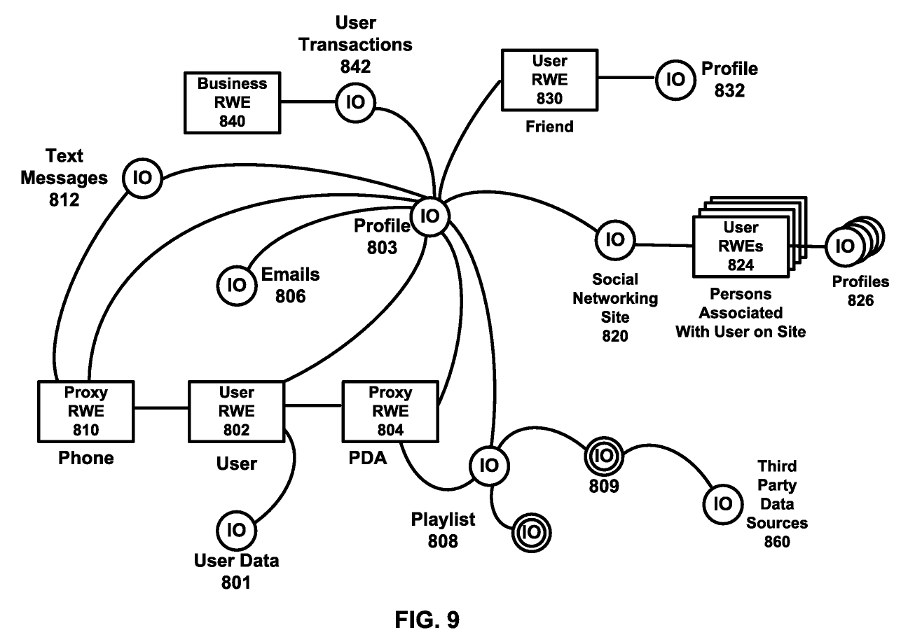

FIG. 9 illustrates one embodiment of a data model showing how the RWEs and IOs shown in FIG. 8 can be related a user's profile within a W4 COMN.

The user's RWE 802 is associated with 2 proxy RWEs 804 and 810 representing the user's PDA and phone respectively. The user RWE is associated with a user profile IO 803. In one embodiment, the user profile IO 803 is a consolidated profile that relates to all data available to the network relating to the user 804. The user profile is directly associated with the passive IOs representing the user's emails 806, playlists 808, text messages 812, and business transactions 842. The user profile 830 is further directly associated with a user RWE 830 representing the user's 804 friend and an active IO 820 representing a social networking site the user 804 is a member of.

The user profile 830 is indirectly associated with user RWEs 824 representing individuals associated with the user 804 on the social networking site 820 and, through the user RWEs 824, profiles 826 for each of such users. The user profile 830 is further indirectly associated with the business RWE 840 through the user's transactions 842. The user profile 830 is further indirectly associated with media objects 809 through the user's playlist 808, and through such media objects 809, with data from third party data sources 860 which relate to the media objects, such as metadata provided by a metadata provider.

The data relationships in the illustrated embodiment are exemplary, and do not exhaust the myriad number of entities and IOs that can be directly or indirectly related to the user 804 and the user's profile 803. The user 804 and the user's profile 804 can be indirectly related to a large, and potentially unbounded set of entities and data known to the network through various data relationships and at varying degrees of separation. For example, the user's friend 830 may patronize different businesses or may have his or her own unique playlists.

In one embodiment, within a W4 COMN, the relationships shown in FIG. 9 are built and maintained by one or more correlation engines within a W4 engine which services the W4 COMN. The creation of such relationships may be automatic and part of the normal operation of the W4 COMN. Alternatively, such relationships can be created on demand.

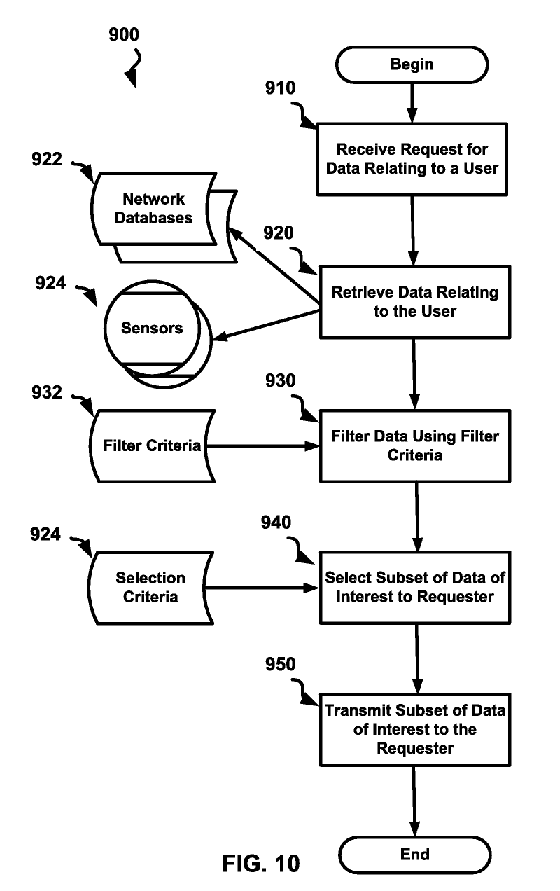

FIG. 10 illustrates one embodiment of a process 900 of how a network, for example, a W4 COMN, can use temporal, spatial, and social data relating to a user to provide a comprehensive profile of the user to other users.

A request is received 910, over a network, from a first user for data relating to a second user. The request comprises, at a minimum, an identification of the second user. The identification of the end user can be, without limitation, a name, a login an email address, a phone number, or any other token or set of tokens that uniquely identifies a user within the network. The identification could comprise a user ID on a social networking website or a URL for a personal BLOG, or even an avatar image.

Alternatively, the identification of the second user could be a generic identification that describes a user using any spatial, temporal, topical or social criteria. For example, the identification may specify users located within the same physical location, such as a restaurant at the same time (a spatial and temporal relationship). In another example, the identification may specify users having mutual friends or family members (a social relationship). In another example, the identification may specify having the same hobbies or by listening to the same songs (topical relationships.) In one embodiment, an identification can relate to a commercial transaction, e.g. I am looking for someone looking to sell a slightly used BMW, am looking for a new furnace.

Spatial, temporal, topical, and social data to the second user are then retrieved 920 from databases 922 and sensors 924 available to the network. In the case of a W4, such data may include any data contained in other RWEs and IOs that are related, directly or indirectly, to the user RWE corresponding to the identification of the second user. In one embodiment, the identification of the second user can be used to locate a consolidated profile, such as IO 830 of FIG. 9, maintained by the network.

The databases 922 may include databases residing on third-party websites, such as social networking sites. In one embodiment, the network is aware of any websites hosting information relating to users and is able to access some or all of such data.

The data relating to the second user is then filtered 930 using at least one filter criteria. In one embodiment, filter criteria are specified by second user and serve to limit other users' ability to view the second user's data. For example, the second user may choose to block all other user's from viewing the second user's transactions, emails, or text messages stored on the network. In one embodiment, filter criteria can contain any combination of spatial, temporal, social, or topical criteria limiting other user's access to the second user's data. Filter criteria can be stated as permissions (i.e. other users can view this data) or as restrictions (i.e. other users cannot view this data.)

Filter criteria can vary in their effect depending on the identity of the inquiring user. Filter criteria can, for example, be relatively permissive for trusted individuals and relatively restrictive for unknown individuals. Criteria can block specific individuals or categories of individuals from viewing specific types of content. For example, suppose a user has a profile on a dating website and on a business networking site. Persons listed as business contacts on the users business networking profile could be blocked from viewing information obtained from the user's dating profile. In another example, a user might normally share her Facebook party pictures with persons at her college, but may choose to block persons whose mother works with the user's mother.

Filter criteria are maintained by the second user, in one embodiment, on a computer readable medium available to the network. The filter criteria can be, without limitation, a component of a user profile associated with the second user, or can be an a separate data object, for example, an IO within a W4 COMN. In one embodiment, filter criteria can be related to one another using standard relational operators. In one embodiment, filter criteria are maintained manually by the second user (e.g. with a text editor), and in another, using a wizard that allows the user to build the criteria using simple drop down menu selections.

A subset of the filtered data is selected 940 using at least one selection criteria. Selection criteria allow the first user to select a subset of the filtered data relating to the second user that is of most interest to the first user. It may often be the case that a large amount of data relating to the second user may be available even after filtering. For example, the second user may have listened to hundreds of tracks of music over the course of a few years, shopped at hundreds of shopping locations, be associated with hundreds of other users on various networking sites, have multiple hobbies, food preferences, and maintain publically accessible blogs of thousands of words.

In one embodiment, selection criteria can contain any combination of spatial, temporal, social, or topical criteria that limit the data returned by a request for information relating to a user. Selection criteria can be positive (i.e. I want to view this kind of data) or negative (i.e. I don't want to view this kind of data.) For example, the first user may wish to restrict the data returned by the request to mutual acquaintances or business contacts both users have in common.

If no selection criteria are explicitly provided, default selection criteria can be used. In one embodiment, if no selection criteria are explicitly provided, the filtered data relating to the second user can be compared to all data available to the network relating to the first user and a subset of data common to both users are selected. For example, such an inquiry could return data reflecting, for example, common interests, common employers, common friends and acquaintances, common business contacts, common locations, common education, common affiliation, and so forth.

In one embodiment, selection criteria are maintained by the first user on a computer readable medium available to the network. The selection criteria can be, without limitation, a component of a user profile associated with the first user, or can be a separate data object, for example, an IO within a W4 COMN. In one embodiment, filter criteria can be related to one another using standard relational operators. In one embodiment, filter criteria are maintained manually by the first user (e.g. with a text editor), and in another, using a wizard that allows the user to build the criteria using simple drop down menu selections. In one embodiment, the selection criteria are included in the request from the first user for data relating to the second user.

Finally, the selected subset of data is transmitted 950 to the first user. The data can transmitted to the second user in any conventional or proprietary format that is viewable by the second user. For example, the data could be formatted as a text file, an XML file, an HTML file or an SMS file. In one embodiment, the data could include links or other information that enable the first user to view additional data relating to the second user. For example, the data could contain hyperlinks to the first user's profiles on social networking sites or to blogs maintained by the first user's profiles. In one embodiment, the data includes a link to a consolidated user profile that allows the first user to view substantially all of the data relating to the second user which is available to the network.

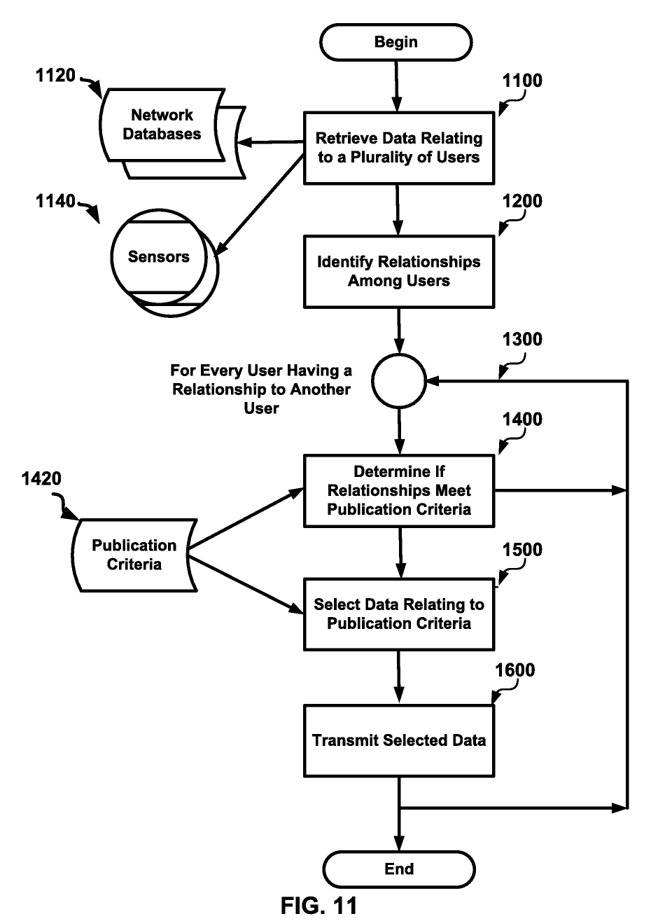

FIG. 11 illustrates one embodiment of a process 1000 of how a network, for example, a W4 COMN, can use temporal, spatial, and social data relating to a user to selectively publish the user's profile data to other users.

Periodically, continuously, or on demand, spatial, temporal, topical, and social data regarding a plurality of users are retrieved 1100 from databases 1120 and sensors 1140 available to the network. In the case of a W4 COMN, such data may include any data contained in other RWEs and IOs that are related, directly or indirectly, to each of the plurality of users. In one embodiment, the data is retrieved using a global index of data available to the network. The data can include data is gathered from a plurality of web sites, each web site hosting data relating to at least one of the plurality of users. Such websites can include, without limitation, social networking sites.

Using processing capabilities available to the network, relationships are then identified 1200 between the plurality of users. In the case of a W4 COMN relationships may be identified along one or more more spatial, temporal, social and topical dimension of the available data. For example, user may be related by being located within the same physical location, such as a restaurant at the same time (a spatial and temporal relationship). In another example, users may be related by having mutual friends or family members (a social relationship). In another example, users may be related by having the same hobbies or by listening to the same songs (topical relationships.)

For each of the plurality of end users having at least one relationship 1300 to at least a second one of the plurality of end users, it is then determined 1400, using processing capabilities available to the network, if the relationships meet publication criteria 1420 for the end user. Where a relationship meets at least one publishing criteria, a subset of the data relating to the end user is selected 1500, using processing capabilities available to the network, where the subset of data relates to the at least one publication criteria 1420. The selected subset of data relating to the end user is then transmitted 1600 to the second one of the plurality of end users.

Publication criteria allow users to selectively determine if they wish to transmit profile information to other users whom with they have some relationship and to limit the profile data transmitted to such users. Publishing criteria can specify a specific relationship. For example, the publication criteria may specify the user wishes to publish profile information to users who engage in a specific type of business (topical), have at least one professional contact in common (social) and who are currently present at a convention or networking event (spatial and temporal). Such criteria may exclude specific relationships, such as family members or users who reside in another city. Publishing criteria can relate to a commercial transaction, e.g. I am looking for to buy a slightly used BMW, I am looking to buy a new furnace. I would sell my rare comic if I could get $400, etc.

Publishing criteria can specify the data that is published and such data can be tuned to the recipient. For example, the publication criteria may specify the user wishes to only publish basic contact information, and mutual business interests to persons who are unknown to the user, but additionally publish the users full social networking profile to persons who are friends of the user's friends. Publication criteria can be positive (i.e. I want to send this kind of data) or negative (i.e. I don't send to this kind of data.)

In one embodiment, publication criteria are maintained by users on a computer readable medium available to the network. The publication criteria can be, without limitation, a component of a user profile associated with the first user, or can be an a separate data object, for example, an IO within a W4 COMN. In one embodiment, publication criteria can be related to one another using standard relational operators. In one embodiment, filter criteria are maintained manually by users (e.g. with a text editor), and in another, using a wizard that allows the user to build the criteria using simple drop down menu selections.

Published data can be transmitted in any conventional or proprietary format that is viewable by the second user. For example, the data could be formatted as a text file, an XML file, an HTML file or an SMS file. In one embodiment, the data could include links or other information that enable the recipient to view additional data relating to the publishing user. For example, the data could contain hyperlinks to the publishing user's profiles on social networking sites or to blogs maintained by the publishing user's profile. In one embodiment, the data includes a link to a consolidated user profile that allows recipients to view substantially all of the data relating to the publishing that is available to the network.

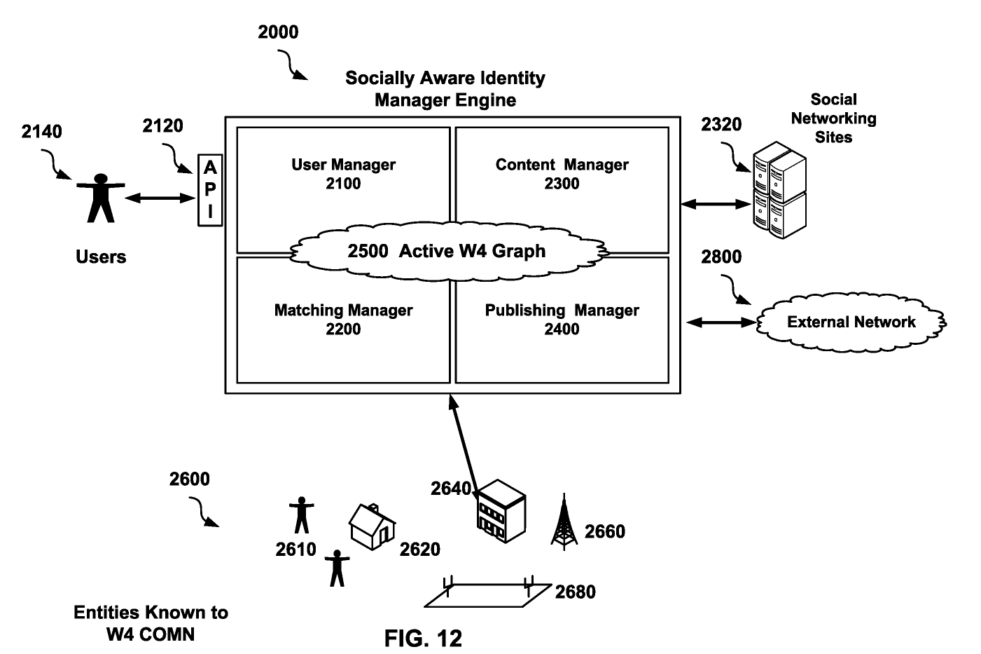

FIG. 12 illustrates one embodiment of a socially aware identity manager engine 2000 capable of supporting the processes shown in FIGS. 10 and 11 above.

The socially aware identity manager engine 2000 comprises four managers, a user manager 2100, a content manager 2300, a matching manager 2200 and a publishing manager 2400. In one embodiment, the socially aware identity manager engine 2000 is a component of a W4 COMN. In another embodiment, the socially aware identity manager engine resides on one or more servers and is connected to a network that has access to spatial, social, temporal and topical data relating to a plurality of users. In one embodiment, each of the managers 2100, 2200, 2300 and 2400 are comprised of one or more modules, some of which can be shared between one or more managers. One or more of such modules may be components of other engines within a W4 COMN.

The W4 COMN continuously gathers spatial, temporal, social data relating to entities known to the network 2600, which can include persons 2610, locations 2620, businesses 2640, sensors 2660, and events 2680. The content manager 2300 gathers information relating to users and entities known to the W4 COMN who maintain data on one or more websites external to the W4 COMN, for example, social networking sites 2320, such as e.g. FaceBook, MySpace, LinkedIn, Y360, etc., personalized media sites, e.g. Flickr, YouTube, etc. and personalized content, e.g. URLs for blogs, websites, professional examples, resumes, etc.

In one embodiment, the content manager 2300 only gathers data from external websites relating to users known to the W4 COMN if users explicitly list the website in a profile and grants permission to the content user to access the content. In another embodiment, the content manager automatically determines what external websites the user maintains data on by, for example, analyzing the content of the user's emails or matching the user's home address or other demographics to data on the external websites.

The data gathered by the W4 COMN relating to entities known to the network 2600 and by the content manager 2300 is continuously or periodically graphed by an active graphing process 2500. In one embodiment, using spatial, temporal, social and topical data available about a specific user, topic or logical data object every entity known to the W4 COMN can be mapped and represented against all other known entities and data objects in order to create both a micro graph for every entity as well as a global graph that relates all known entities with one another. In one embodiment, such relationships between entities and data objects are stored in a global index within the W4 COMN.

The user manager 2100 provides facilities that allow end users to access the services of the socially aware identity manager engine 2000. The user manager 2100 provides at least one interface that allow users to enter in requests for data relating to others users. Such requests each comprise, at a minimum, an identification of an end user. The identification of the end user can be, without limitation, a name, a login an email address, or any other token or set of tokens that uniquely identifies a user within the network. The identification could comprise a user ID on a social networking website. Alternatively, the identification of the second user could be a generic identification that describes a user using any spatial, temporal, topical or social criteria. In one embodiment, such identification criteria can be related to one another using standard relational operators.

The user manager 2100 can further provide one or more interfaces that allow to users to maintain filter criteria that to limit other users' ability to view the user's data. In one embodiment, filter criteria can contain any combination of spatial, temporal, social, or topical criteria limiting other user's access to the second user's data. Filter criteria can be stated as permissions (i.e. other users can view this data) or as restrictions (i.e. other users cannot view this data.) Selection criteria can be positive or negative. In one embodiment, selection criteria can be related to one another using standard relational operators.

The user manager 2100 can further provide one or more interfaces that allow to users to maintain selection criteria that allow users who have entered requests for data relating to other users to select a subset of data relating to the other users that are of most interest to the requesting users. In one embodiment, selection criteria can contain any combination of spatial, temporal, social, or topical criteria that limit the data returned by a request for information relating to a user. Selection criteria can be positive or negative. In one embodiment, selection criteria can be related to one another using standard relational operators.

The user manager 2100 can further provide one or more interfaces that allow to users to maintain publication criteria that allow users to selective determine if they wish to transmit profile information to other users with whom they have some relationship and to limit data transmitted to such users. In one embodiment, publication criteria can contain any combination of spatial, temporal, social, or topical criteria that determine what, if any data is to be published to other users. In one embodiment, filter criteria can contain any combination of spatial, temporal, social, or topical criteria limiting other user's access to the second user's data. In one embodiment, publication criteria can be related to one another using standard relational operators.

In one embodiment, filter, selection and publication criteria can be stored by the user manager on a computer readable medium available to the network. The filter, selection and publication criteria can be, without limitation, a component of a user profile maintained by a user using the facilities of the user manager, or can be stored as logical IO on a W4 COMN. In one embodiment, the user manager provides a wizard that allows the user to build the criteria using simple drop down menu selections. In one embodiment, filter, selection and publication criteria can be manually maintained on a computer readable medium available to the network.

The interfaces provided the user manager 2100 may be a graphical user interface displayable on mobile phones, gaming devices, computers or PDAs, including HTTP documents accessible over the Internet. Such interfaces may also take other forms, including text files, such as SMS, emails, and APIs usable by software applications located on computing devices.

The matching manager 2100 provides facilities that match data relating to users to, without limitation, requests for data relating to a user or to data relating to other users. In one embodiment, the matching manager 2300 matches identifications of users in requests received by the user manager 2100 for information to users known to the network and retrieves spatial, temporal, topical, and social data available to the network relating to such users. In one embodiment, an identification of a user can be used to locate a consolidated profile, such as IO 830 of FIG. 9, maintained by the network.

In one embodiment, the matching manager 2300 can further filter data relating to users which is retrieved in response to requests for information relating to such users using filter criteria maintained, without limitation through the user manger 2100. In one embodiment, the matching manager 2300 can further select subsets of filtered data is selected selection criteria maintained, without limitation, through the user manger 2100.

In one embodiment, the matching manager 2300 can further periodically, continuously, or on demand, retrieve spatial, temporal, topical, and social data available to the network regarding a plurality of users and identify relationships among the plurality of users. Relationships may be identified using one or more spatial, temporal, social and topical dimension of the available data. The matching manager can then determine if identified relationships meet publishing criteria for users maintained, without limitation through the user manger 2100. In one embodiment, the matching manager 2300 can further select data to be published to recipients of published data using publishing criteria.

In one embodiment, within the matching manager 2300, a global ID graph is created so that each user's own unique footprint of IDs, profiles, memberships and media are mapped with all other known users based upon their W4 profiles within a W4 COMN, or upon some other shared model of interests, shared content, memberships or relations, location and proximity, movement and association in real-time and online. By providing a unified method for comparing users based upon their data profiles, the global ID graph provides a real-time resource for informing the matching of user data to user data requests.

In one embodiment, the selection and matching of data for delivery to users is not limited to exclusively considering the data of the users involved, but can also informed by the collaborative filtering of actual usage patterns among all known users including developing templates over time for data presentation or filtering based upon context, association or other intersection of W4 data shown meaningful on the basis of actual user introductions and profile, contact information or membership updating.

The publishing manager 2400 transmits (i.e. “publishes”) data retrieved, selected and filtered by the other components of the socially aware identity engine 2000 to its intended recipients. In the case of a request for information about a user, the data is transmitted to the requesting user. In the case of a publication generated by publishing criteria, the data is transmitted to users identified as having relationships to a publishing user that meet one or more publication criteria. In one embodiment, the data is transmitted over an external network 2800, for example, the Internet.

Data relating to a second user can transmitted to a first user in any conventional or proprietary format that is viewable by the first user. For example, the data could be formatted as a text file, an XML file, an HTML file or an SMS file. In one embodiment, the data could include links or other information that enable the first user to view additional data relating to the second user. For example, the data could contain hyperlinks to the second user's profiles on social networking sites or to blogs maintained by the second user.

In one embodiment, the data includes a link to a consolidated user profile that allows the receiving user to view substantially all of the data relating to the publishing user which is available to the network. In alternative embodiments, the transmitted data creates a “beachhead” first display of ID or profile information on one user to another user, but is instrumented to allow the receiving user to browse and navigate across all of the user's data. For the example, socially aware identity manger engines 2000 may send a user a second user's Facebook profile because both are active members of Facebook, but then it instruments the display to list the second user's LinkedIn and Flickr memberships using, for example, links.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein, Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
receiving a request, over a network, from a first user for data relating to a second user, wherein the request comprises an identification of the second user;
retrieving spatial, temporal, topical, and social data available to the network relating to the second user using a global index of data available to the network;
filtering, via the network, the data relating to the second user, using at least one filter criteria;
selecting, via the network, a subset of the filtered data relating to the second user using at least one selection criteria;
transmitting, over the network, the filtered subset of data relating to the second user to the first user.

2. The method of claim 1 wherein the identification of the second user comprises at least one token that uniquely identifies the second user.

3. The method of claim 2 wherein the at least one token is selected from the list: login on a website, email address, name, name and address, phone number, user ID on a social networking website, and URL for a personal BLOG, avatar image.

4. The method of claim 1 wherein the identification of the second user is a generic identification comprising spatial, temporal, topical and social criteria.

5. The method of claim 1 wherein the request additionally comprises the at least one selection criteria.

6. The method of claim 1 wherein the spatial, temporal, topical, and social data available to the network comprises at least one website comprising data relating to the second user.

7. The method of claim 6 wherein at least one website is a social networking website.

8. The method of claim 1 wherein the spatial, temporal, topical, and social data available to the network comprises a consolidated profile for the second user.

9. The method of claim 1 wherein the at least one filter criteria comprises spatial, temporal, social, and topical criteria.

10. The method of claim 1 wherein the at least one selection criteria comprises spatial, temporal, social, and topical criteria.

11. The method of claim 1 wherein the at least one selection criteria comprises criteria that select data common to both users.

12. The method of claim 11 wherein the data common to both users is selected from the list: common interests, common employers, common friends, common business contacts, common locations, common education, common affiliation.

13. The method of claim 1 wherein the filtered subset of data relating to the second user is transmitted in a format selected from the list: text file, XML file, HTML file, SMS file.

14. The method of claim 1 wherein the filtered subset of data relating to the second user comprises at least one link to a website containing data relating to the second user.

15. The method of claim 1 wherein the filtered subset of data relating to the second user comprises at least one link to a consolidated profile for the second user.

16. The method of claim 1 wherein the filtered subset of data relating to the second user comprises at least one link to the substantially all of the data relating to the second user which is available to the network.

17. A method comprising:
gathering, over a network, spatial, temporal, topical, and social data available to the network relating to a plurality of users using a global index of data available to the network;
identifying, via the network, relationships among the plurality of users using the gathered data;
for each of the plurality of end users having at least one relationship to at least a second one of the plurality of end users;
determining, via the network, if the at least one relationship meets at least one publication criteria, and, if so
selecting, via the network, a subset of the data relating to the at least a second one of the plurality of end users that relates to at least one publication criteria;
transmitting, over the network subset of the data relating to the at least a second one of the plurality of end users to the end user having the at least one relationship to the at least a second one of the plurality of end users.

18. The method of claim 17 wherein the spatial, temporal, topical, and social data available to the network comprises at least one website comprising data relating to at least one of plurality of end users.

19. The method of claim 17 wherein the spatial, temporal, topical, and social data available to the network comprises a consolidated profile for at least one of plurality of end users.

20. The method of claim 17 wherein the at least one publication criteria comprises spatial, temporal, social, and topical criteria.

21. The method of claim 17 wherein the subset of the data relating to the at least a second one of the plurality of end users is transmitted in a format selected from the list: text file, XML file, HTML file, SMS file.

22. The method of claim 17 wherein subset of the data relating to the at least a second one of the plurality of end users comprises at least one link to a website containing data relating to the at least a second one of the plurality of end users.

23. The method of claim 17 wherein subset of the data relating to the at least a second one of the plurality of end users comprises at least one link to a consolidated user profile for the at least a second one of the plurality of end users.

24. The method of claim 17 wherein subset of the data relating to the at least a second one of the plurality of end users comprises at least one link to substantially all of the data relating to the at least a second one of the plurality of end users which is available to the network.

25. A system comprising:
a user manager that receives requests, over a network, from a first user for data relating to a second user, wherein the request comprises an identification of the second user;
a matching manager that:
retrieves spatial, temporal, topical, and social data available to the network relating to the first user and the second user using a global index of data available to the network;
filters the data relating to the second user, using at least one filter criteria; and
selects a subset of the filtered data relating to the second user using at least one selection criteria; and
a publishing manager that transmits, over the network, the filtered subset of data relating to the second user to the first user.

26. The system of claim 25 wherein the identification of the second user comprises at least one token that uniquely identifies the second user.

27. The system of claim 25 wherein the at least one token is selected from the list: login on a website, email address, name, name and address, phone number, user ID on a social networking website, and URL for a personal BLOG, avatar image.

28. The system of claim 25 wherein the identification of the second user is a generic identification comprising spatial, temporal, topical and social criteria.

29. The system of claim 25 wherein the request additionally comprises the at least one selection criteria.

30. The system of claim 25 wherein the spatial, temporal, topical, and social data available to the network comprises at least one website comprising data relating to the second user.

31. The system of claim 30 wherein at least one website is a social networking website.

32. The system of claim 25 wherein the spatial, temporal, topical, and social data available to the network comprises a consolidated profile for the second user.

33. The system of claim 25 wherein the at least one filter criteria comprises spatial, temporal, social, and topical criteria.

34. The system of claim 25 wherein the at least one selection criteria comprises spatial, temporal, social, and topical criteria.

35. The system of claim 25 wherein the at least one selection criteria comprises criteria that select data common to both users.

36. The system of claim 35 wherein the data common to both users is selected from the list: common interests, common employers, common friends, common business contacts, common locations, common education, common affiliation.

37. The system of claim 25 wherein subset of the filtered data relating to the second user is transmitted in a format selected from the list: text file, XML file, HTML file, SMS file.

38. The system of claim 25 wherein subset of the filtered data relating to the second user comprises at least one link to a website containing data relating to the second user.

39. The system of claim 25 wherein subset of the filtered data relating to the second user comprises at least one link to a consolidated user profile.

40. The system of claim 25 wherein subset of the filtered data relating to the second user is comprises at least one link to the substantially all of the data relating to the second user which is available to the network.

41. A system comprising:
a matching manager that:
gathers, over a network, spatial, temporal, topical, and social data relating to a plurality of users using a global index of data available to the network,
identifies relationships among the plurality of users using the gathered data;
for each of the plurality of end users having at least one relationship to at least a second one of the plurality of end users:
determines if the at least one relationship meets at least one publication criteria, and, if so
selects, via the network, a subset of the data relating to the at least a second one of the plurality of end users that relates to at feast one publication criteria;
a publishing manager that transmits, over the network the subset of the data relating to the at least a second one of the plurality of end users to the end user having the at least one relationship to the at least a second one of the plurality of end users.

42. The system of claim 41 wherein the spatial, temporal, topical, and social data available to the network comprises at least one website comprising data relating to at least one of plurality of end users.

43. The system of claim 41 wherein the spatial, temporal, topical, and social data available to the network comprises a consolidated profile for at least one of plurality of end users.

44. The system of claim 41 wherein the at least one publication criteria for at least one of the plurality of end users comprises spatial, temporal, social, and topical criteria.

45. The system of claim 41 wherein the subset of the data relating to the at least a second one of the plurality of end users is transmitted in a format selected from the list: text file, XML file, HTML file, SMS file.

46. The system of claim 41 wherein the subset of the data relating to the at least a second one of the plurality of end users comprises at least one link to a website containing data relating to the at least a second one of the plurality of end users.

47. The system of claim 41 wherein the subset of the data relating to the at least a second one of the plurality of end users comprises at least one link to a consolidated user profile for the at least a second one of the plurality of end users.

48. The system of claim 41 wherein the subset of the data relating to the at least a second one of the plurality of end users comprises at least one link to the substantially all of the data relating to the at least a second one of the plurality of end users which is available to the network.

49. A computer-readable medium having computer-executable instructions for a method comprising the steps of:
receiving a requests over a network, from a first user for data relating to a second user, wherein the request comprises an identification of the second user;
retrieving spatial, temporal, topical, and social data available to the network relating to the second user using a global index of data available to the network;
filtering, via the network, the data relating to the second user, using at least one filter criteria;
selecting, via the network, a subset of the filtered data relating to the second user using at least one selection criteria;
transmitting, over the network, the filtered subset of data relating to the second user to the first user.

50. The computer-readable medium of claim 49 wherein the identification of the second user comprises at least one token that uniquely identifies the second user.

51. The computer-readable medium of claim 50 wherein the at least one token is selected from the list: login on a website, email address, name, name and address, phone number, user ID on a social networking website, and URL for a personal BLOG, avatar image.

52. The computer-readable medium of claim 49 wherein the identification of the second user is a generic identification comprising spatial, temporal, topical and social criteria.

53. The computer-readable medium of claim 49 wherein the request additionally comprises the at least one selection criteria.

54. The computer-readable medium of claim 49 wherein the spatial, temporal, topical, and social data available to the network comprises at least one website comprising data relating to the second user.

55. The computer-readable medium of claim 54 wherein at least one website is a social networking website.

56. The computer-readable medium of claim 49 wherein the spatial, temporal, topical, and social data available to the network comprises a consolidated profile for the second user.

57. The computer-readable medium of claim 49 wherein the at least one filter criteria comprises spatial, temporal, social, and topical criteria.

58. The computer-readable medium of claim 49 wherein the at least one selection criteria comprises spatial, temporal, social, and topical criteria.

59. The computer-readable medium of claim 49 wherein the at least one selection criteria comprises criteria that select data common to both users.

60. The computer-readable medium of claim 59 wherein the data common to both users is selected from the list: common interests, common employers, common friends, common business contacts, common locations, common education, common affiliation.

61. The computer-readable medium of claim 49 wherein the filtered subset of data relating to the second user is transmitted in a format selected from the list: text file, XML file, HTML file, SMS file.

62. The computer-readable medium of claim 49 wherein the filtered subset of data relating to the second user comprises at least one link to a website containing data relating to the second user.

63. The computer-readable medium of claim 49 wherein the filtered subset of data relating to the second user comprises at least one link to a consolidated profile for the second user.

64. The computer-readable medium of claim 49 wherein the filtered subset of data relating to the second user comprises at least one link to the substantially all of the data relating to the second user which is available to the network.

65. A computer-readable medium having computer-executable instructions for a method comprising the steps of:
gathering, over a network, spatial, temporal, topical, and social data available to the network relating to a plurality of users using a global index of data available to the network;
identifying, via the network, relationships among the plurality of users using the gathered data;
for each of the plurality of end users having at least one relationship to at least a second one of the plurality of end users:
determining, via the network, if the at least one relationship meets at least one publication criteria, and, if so
selecting, via the network, a subset of the data relating to the at least a second one of the plurality of end users that relates to at least one publication criteria;
transmitting, over the network subset of the data relating to the at least a second one of the plurality of end users to the end user having the at least one relationship to the at least a second one of the plurality of end users.

66. The computer-readable medium of claim 65 wherein the spatial, temporal, topical, and social data available to the network comprises at least one website comprising data relating to at least one of plurality of end users.

67. The computer-readable medium of claim 65 wherein the spatial, temporal, topical, and social data available to the network comprises a consolidated profile for at least one of plurality of end users.

68. The computer-readable medium of claim 65 wherein the at least one publication criteria comprises spatial, temporal, social, and topical criteria.

69. The computer-readable medium of claim 65 wherein the subset of the data relating to the at least a second one of the plurality of end users is transmitted in a format selected from the list: text file, XML file, HTML file, SMS file.

70. The computer-readable medium of claim 65 wherein subset of the data relating to the at least a second one of the plurality of end users comprises at least one link to a website containing data relating to the at least a second one of the plurality of end users.

71. The computer-readable medium of claim 65 wherein subset of the data relating to the at least a second one of the plurality of end users comprises at least one link to a consolidated user profile for the at least a second one of the plurality of end users.

72. The computer-readable medium of claim 65 wherein subset of the data relating to the at least a second one of the plurality of end users comprises at least one link to substantially all of the data relating to the at least a second one of the plurality of end users which is available to the network.
